(19) United States
(12) Patent Application Publication
(10) Pub. No.: US 2025/0344700 A1
(43) Pub. Date: Nov. 13, 2025

(54) SODIUM CHLORITE TABLET FOR CONTROLLING ALGAL GROWTH IN WATER AND METHOD OF MAKING THE SAME

(71) Applicant: The Hong Kong University of Science and Technology, Hong Kong (CN)

(72) Inventors: KING LUN YEUNG, Hong Kong (CN); NING ZHAN, Hong Kong (CN); WEI HAN, Hong Kong (CN); JOSEPH KAI CHO KWAN, Hong Kong (CN)

(73) Assignee: The Hong Kong University of Science and Technology, Hong Kong (CN)

(21) Appl. No.: 19/203,249

(22) Filed: May 9, 2025

Related U.S. Application Data
(60) Provisional application No. 63/644,510, filed on May 9, 2024.

(51) Int. Cl. A01N 59/00; A01N 25/08; A01N 25/34; A01P 13/00

(52) U.S. Cl. CPC A01N 59/00; A01N 25/08; A01N 25/34; A01P 13/00

(57) ABSTRACT

The sodium chlorite tablet includes sodium chlorite in a matrix material. The sodium chlorite has a concentration between 0.5 wt. % and 20 wt. % of the sodium chlorite tablet. The sodium chlorite tablet further includes a binding agent having a concentration less than or equal to 5.0 wt. % of the sodium chlorite tablet. The sodium chlorite tablet is made by mixing the matrix material with the sodium chlorite to form a first mixture. The binding agent is mixed into the first mixture to form a second mixture. The second mixture is tableted to form the sodium chlorite tablet. Alternatively, the sodium chlorite tablet may be made by diluting colloidal silica sol in water. The sodium chlorite is added to the diluted colloidal silica sol to form a mixture, and the mixture is placed in a tablet mold and allowed to convert the colloidal silica sol into a gel.

### CROSS-REFERENCE TO RELATED APPLICATIONS

This application claims the benefit of U.S. Provisional Patent Application No. 63/644,510, filed on May 9, 2024.

### BACKGROUND

### Field

The disclosure of the present patent application relates to the control of the growth of algae in water, and particularly to a tablet which is dissolvable in water for the release of sodium chlorite into the water for control of algal growth therein.

### Description of Related Art

Algal growth is a major problem in bodies of water due to availability of nutrients to support the algae, particularly in the form of phosphorus and nitrogen from runoff water. The growth of algae can lead to the production of toxins and disinfection by-products (DBPs), such as trihalomethanes and haloacetic acids, which can have adverse health effects on people, particularly in the elderly, children and pregnant women. Control over algal growth has been approached in numerous ways, including implementing new policies, applying engineering solutions, and developing new scientific approaches. However, thus far, each approach has enjoyed only limited success. For example, engineering strategies, such as solar-powered circulation units and underwater mixers, consume large amounts of energy and do not solve the odor and taste problem that results from the decomposition of algae. Although natural and synthetic algaecides have shown efficient and wide-spectrum algicidal activities, their direct addition to water often results in rapid consumption of the algaecides and non-selective suppression of all aquatic organisms.

In order to effectively use algaecides, a storage and dosing mechanism must be developed in order to prevent the rapid consumption thereof. Sustained release or dosing of the algaecide would be necessary to provide sustained inhibition of algal growth and prevent excessive dosing, while also avoiding unwanted disinfection products and minimizing the impact on the aquatic environment.

Thus, a sodium chlorite tablet for controlling algal growth in water and a method of making the same solving the aforementioned problems are desired.

### SUMMARY

The sodium chlorite tablet includes sodium chlorite in a matrix material. The sodium chlorite tablet is dissolvable in water for the release of the sodium chlorite for controlling the growth of algae in the water. The sodium chlorite has a concentration between 0.5 wt. % and 20 wt. % of the sodium chlorite tablet. The sodium chlorite tablet further includes a binding agent having a concentration less than or equal to 5.0 wt. % of the sodium chlorite tablet. As a non-limiting example, the matrix material may be sand. As another non-limiting example, the matrix material may be an inorganic powder, such as, but not limited to, silica powder, inorganic oxide powder, zeolite powder, porous inorganic oxide powder, or clay powder. The inorganic oxide powder may be, but is not limited to, alumina oxide powder, alumina oxide-silica oxide powder, titania powder, or combinations thereof. The binding agent may be, but is not limited to, a polymer binder, a clay binder, a silica binder, bentonite clay, polyvinylacetate, polyethylenimine or combinations thereof.

As a further non-limiting example, the matrix material may be silylated cellulose. Non-limiting examples of the silylated cellulose include silylated methyl cellulose, silylated carboxymethyl cellulose, silylated cotton, or combinations thereof. As another non-limiting example, the matrix material may be silica hydrogel.

The sodium chlorite tablet is made by mixing the matrix material with the sodium chlorite to form a first mixture. The binding agent is mixed into the first mixture to form a second mixture. The second mixture is tableted to form the sodium chlorite tablet with a sodium chlorite concentration between 0.5 wt. % and 20 wt. % of the sodium chlorite tablet, and with a binding agent concentration less than or equal to 5.0 wt. % of the sodium chlorite tablet. An activating agent may be added to the first mixture, such as, but not limited to, tartaric acid impregnated activated carbon, tartaric acid powder, citric acid impregnated activated carbon, or maleic acid impregnated activated carbon. As a further alternative, a co-disinfectant may be added to the first mixture, such as, but not limited to, polyhexamethylene biguanide, copper sulfate, or a combination thereof.

In an alternative embodiment, the sodium chlorite tablet is made by diluting colloidal silica sol in water. The sodium chlorite is added to the diluted colloidal silica sol to form a mixture, and the mixture is placed in a tablet mold and allowed to convert the colloidal silica sol into a gel.

These and other features of the present subject matter will become readily apparent upon further review of the following specification.

### BRIEF DESCRIPTION OF DRAWINGS

FIG. 1 is a plot showing the time-release of sodium chlorite from a sodium chlorite tablet with a silica hydrogel matrix.

FIG. 2 is a plot showing the algicidal activity over time of the sodium chlorite tablet with a silica hydrogel matrix.

FIG. 3A shows an optical microscope image of live Chlorella spp. on a counting plate taken from a control reservoir.

FIG. 3B shows an optical microscope image of dead Chlorella spp. on a counting plate taken from a test reservoir treated with the sodium chlorite tablet with a silica hydrogel matrix.

FIG. 4A is a graph showing mean sodium chlorite concentration in water samples taken over 10 days in the control and test reservoirs of FIGS. 3A and 3B.

FIG. 4B is a graph showing average algae concentration in water samples taken over 10 days from the control and test reservoirs of FIGS. 3A and 3B.

Similar reference characters denote corresponding features consistently throughout the attached drawings.

### DETAILED DESCRIPTION

The sodium chlorite tablet includes sodium chlorite in a matrix material. The sodium chlorite tablet is dissolvable in water for the release of the sodium chlorite for controlling the growth of algae in the water. The sodium chlorite has a concentration between 0.5 wt. % and 20 wt. % of the sodium chlorite tablet. The sodium chlorite tablet further includes a binding agent having a concentration less than or equal to 5.0 wt. % of the sodium chlorite tablet. As a non-limiting example, the matrix material may be sand. As another non-limiting example, the matrix material may be an inorganic powder, such as, but not limited to, silica powder, inorganic oxide powder, zeolite powder, porous inorganic oxide powder, or clay powder. The inorganic oxide powder may be, but is not limited to, alumina oxide powder, alumina oxide-silica oxide powder, titania powder, or combinations thereof. The binding agent may be, but is not limited to, a polymer binder, a clay binder, a silica binder, bentonite clay, polyvinylacetate, polyethylenimine or combinations thereof.

As a further non-limiting example, the matrix material may be silylated cellulose. Non-limiting examples of the silylated cellulose include silylated methyl cellulose, silylated carboxymethyl cellulose, silylated cotton, or combinations thereof. As another non-limiting example, the matrix material may be silica hydrogel.

The sodium chlorite tablet is made by mixing the matrix material with the sodium chlorite to form a first mixture. The binding agent is mixed into the first mixture to form a second mixture. The second mixture is tableted to form the sodium chlorite tablet with a sodium chlorite concentration between 0.5 wt. % and 20 wt. % of the sodium chlorite tablet, and with a binding agent concentration less than or equal to 5.0 wt. % of the sodium chlorite tablet. An activating agent may be added to the first mixture, such as, but not limited to, tartaric acid impregnated activated carbon, tartaric acid powder, citric acid impregnated activated carbon, or maleic acid impregnated activated carbon. As a further alternative, a co-disinfectant may be added to the first mixture, such as, but not limited to, polyhexamethylene biguanide, copper sulfate, or a combination thereof.

In an alternative embodiment, the sodium chlorite tablet is made by diluting colloidal silica sol in water. The sodium chlorite is added to the diluted colloidal silica sol to form a mixture, and the mixture is placed in a tablet mold and allowed to convert the colloidal silica sol into a gel.

### Example 1

A gram of sodium chlorite powder was mixed with 30 g of sand to form a homogeneous mixture. Afterward, ten grams of colloidal silica (AS-40) were added along with 2 milliliters of 0.14 M nitric acid as a binding agent. The mixture was tableted and allowed to dry. The concentration of the sodium chlorite in the final tablet is 3.0 wt. %.

### Example 2

8.5 grams of sodium chlorite powder was mixed with 30 g of sand to form a homogeneous mixture. Afterward, ten grams of colloidal silica (AS-40) were added along with 2 milliliters of 0.14 M nitric acid as a binding agent. The mixture was tableted and allowed to dry. The concentration of the sodium chlorite in the final tablet is 20.0 wt. %.

### Example 3

8.5 grams of sodium chlorite powder was mixed with 30 g of sand to form a homogeneous mixture. 0.5 g of tartaric acid impregnated activated carbon was added to the mixture to serve as an activating agent. Afterward, five grams of colloidal silica (AS-40) were added along with 1 milliliters of 0.14 M nitric acid as binding agent. The mixture was tableted and allowed to dry. The concentration of the sodium chlorite in the final tablet is 20.0 wt. %.

### Example 4

8.5 grams of sodium chlorite powder was mixed with 32.8 g of sand to form a homogeneous mixture. 0.5 g bentonite clay, 0.5 g polyvinylacetate, and 0.2 g polyethylenimine are added as binder, and the dry mixture was tableted at 100-500 MPa. The concentration of the sodium chlorite in the final tablet is 20.0 wt. %.

### Example 5

8.5 grams of sodium chlorite powder was mixed with 32.6 g of sand to form a homogeneous mixture. 0.2 g tartaric acid powder was added as an activating agent, and 0.5 g bentonite clay, 0.5 g polyvinylacetate, and 0.2 g polyethylenimine were added as binders. The mixture was tableted at 400 MPa. The concentration of the sodium chlorite in the final tablet is 20.0 wt. %.

### Example 6

8.5 grams of sodium chlorite powder was mixed with 32.6 g of sand to form a homogeneous mixture. 0.2 g of citric acid impregnated activated carbon was added as an activating agent, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 7

8.5 grams of sodium chlorite powder was mixed with 32.6 g of sand to form a homogeneous mixture. 0.2 g of maleic acid impregnated activated carbon was added as an activating agent, and 0.5 g bentonite clay, 0.5 g polyvinylacetate, and 0.5 g polyethylenimine were added as binders. The mixture was tableted at 400 MPa. The concentration of the sodium chlorite in the final tablet is 20.0 wt. %.

### Example 8

8.5 grams of sodium chlorite powder was mixed with 32.0 g of sand to form a homogeneous mixture. 0.5 g of tartaric acid impregnated activated carbon was added as an activating agent, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 9

8.5 grams of sodium chlorite powder was mixed with 32.0 g of sand to form a homogeneous mixture. 0.5 g of maleic acid impregnated activated carbon was added as an activating agent, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 10

A gram of sodium chlorite powder was mixed with 30 g of silica powder to form a homogeneous mixture. Afterward, ten grams of colloidal silica (AS-40) were added along with 2 milliliters of 0.14 M nitric acid as a binding agent. The mixture was tableted and allowed to dry. The concentration of the sodium chlorite in the final tablet is 3.0 wt. %.

### Example 11

8.5 grams of sodium chlorite powder was mixed with 30 g of silica powder to form a homogeneous mixture. Afterward, ten grams of colloidal silica (AS-40) were added along with 2 milliliters of 0.14 M nitric acid as a binding agent. The mixture was tableted and allowed to dry. The concentration of the sodium chlorite in the final tablet is 20.0 wt. %.

### Example 12

8.5 grams of sodium chlorite powder was mixed with 30 g of silica to form a homogeneous mixture. 0.5 g of tartaric acid impregnated activated carbon was added to the mixture to serve as an activating agent. Afterward, five grams of colloidal silica (AS-40) were added along with 1 milliliter of 0.14 M nitric acid as a binding agent. The mixture was tableted and allowed to dry. The concentration of the sodium chlorite in the final tablet is 20.0 wt. %.

### Example 13

8.5 grams of sodium chlorite powder was mixed with 32.7 g of silica to form a homogeneous mixture. 0.5 g bentonite clay, 0.5 g polyvinylacetate, and 0.3 g polyethylenimine were added as binders, and the dry mixture was tableted at 100-500 MPa. The concentration of the sodium chlorite in the final tablet is 20.0 wt. %.

### Example 14

8.5 grams of sodium chlorite powder was mixed with 32.6 g of silica to form a homogeneous mixture. 0.2 g tartaric acid powder was added as an activating agent, and 0.5 g bentonite clay, 0.5 g polyvinylacetate, and 0.2 g polyethylenimine were added as binders. The mixture was tableted at 400 MPa. The concentration of the sodium chlorite in the final tablet is 20.0 wt. %.

### Example 15

8.5 grams of sodium chlorite powder was mixed with 32.6 g of silica to form a homogeneous mixture. 0.2 g of citric acid impregnated activated carbon was added as an activating agent, and 0.5 g bentonite clay, 0.5 g polyvinylacetate, and 0.5 g polyethylenimine were added as binders. The mixture was tableted at 400 MPa. The concentration of the sodium chlorite in the final tablet is 20.0 wt. %.

### Example 16

8.5 grams of sodium chlorite powder was mixed with 32.6 g of silica to form a homogeneous mixture. 0.2 g of maleic acid impregnated activated carbon was added as an activating agent, and 0.5 g bentonite clay, 0.5 g polyvinylacetate, and 0.5 g polyethylenimine were added as binders. The mixture was tableted at 400 MPa. The concentration of the sodium chlorite in the final tablet is 20.0 wt. %.

### Example 17

8.5 grams of sodium chlorite powder was mixed with 32.0 g of silica to form a homogeneous mixture. 0.5 g of tartaric acid impregnated activated carbon was added as an activating agent, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 18

8.5 grams of sodium chlorite powder was mixed with 30.0 g of silica to form a homogeneous mixture. 0.5 g of tartaric acid impregnated activated carbon was added as an activating agent. 2.0 g polyhexamethylene biguanide was added as a co-disinfectant, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 19

8.5 grams of sodium chlorite powder was mixed with 30.3 g of silica to form a homogeneous mixture. 0.2 g tartaric acid was added as an activating agent. 2.0 g polyhexamethylene biguanide and 0.2 g copper sulfate were added as a co-disinfectant, and 0.5 g bentonite clay, 0.5 g polyvinylacetate, and 0.5 g polyethylenimine were added as binders. The mixture was tableted at 200 MPa. The concentration of the sodium chlorite in the final tablet is 20.0 wt. %.

### Example 20

4.25 grams of sodium chlorite and 4.25 grams of sodium hypochlorite powder were mixed with 30.3 g of silica to form a homogeneous mixture. 0.2 g of tartaric acid was added as an activating agent, and 0.5 g bentonite clay, 0.5 g polyvinylacetate, and 0.5 g polyethylenimine were added as binders, before tableting the mixture at 200 MPa. The concentration of the sodium chlorite in the final tablet is 10.0 wt. % and the concentration of sodium hypochlorite in the final tablet is 10.0 wt. %.

### Example 21

8.5 grams of sodium chlorite powder was mixed with 32.7 g of alumina to form a homogeneous mixture. 0.5 g bentonite clay, 0.5 g polyvinylacetate, and 0.3 g polyethylenimine were added as binders, and the dry mixture was tableted at 100-500 MPa. The concentration of the sodium chlorite in the final tablet is 20.0 wt. %.

### Example 22

8.5 grams of sodium chlorite powder was mixed with 32.7 g of alumina to form a homogeneous mixture. 0.2 g of maleic acid impregnated activated carbon was added as an activating agent, and 0.5 g bentonite clay, 0.5 g polyvinylacetate, and 0.5 g polyethylenimine were added as binders. The mixture was tableted at 400 MPa. The concentration of the sodium chlorite in the final tablet is 20.0 wt. %.

### Example 23

8.5 grams of sodium chlorite powder was mixed with 30.3 g of a 1:1 mixture of alumina and silica to form a homogeneous mixture. 0.2 g tartaric acid was added as an activating agent. 2.0 g polyhexamethylene biguanide and 0.2 g copper sulfate were added as a co-disinfectant, and 0.5 g bentonite clay, 0.5 g polyvinylacetate, and 0.5 g polyethylenimine were added as binders, before tableting the mixture at 200 MPa. The concentration of the sodium chlorite in the final tablet is 20.0 wt. %.

### Example 24

8.5 grams of sodium chlorite powder was mixed with 30.3 g of zeolite 4A to form a homogeneous mixture. 0.2 g tartaric acid was added as an activating agent. 2.0 g polyhexamethylene biguanide and 0.2 g copper sulfate were added as a co-disinfectant, and 0.5 g bentonite clay, 0.5 g polyvinylacetate, and 0.5 g polyethylenimine were added as binders, before tableting the mixture at 300 MPa. The concentration of the sodium chlorite in the final tablet is 20.0 wt. %.

### Example 25

8.5 grams of sodium chlorite powder was mixed with 30.5 g of zeolite 13X to form a homogeneous mixture. 0.2 g tartaric acid was added as an activating agent. 2.0 g polyhexamethylene biguanide was added as a co-disinfectant, and 0.5 g bentonite clay, 0.5 g polyvinylacetate, and 0.5 g polyethylenimine were added as binders, before tableting the mixture at 300 MPa. The concentration of the sodium chlorite in the final tablet is 20.0 wt. %.

### Example 26

1.0 gram of sodium chlorite was dissolved in 15 milliliters of water, and slowly added to 9.0 gram of dry silica powder until incipient wetness. The impregnated power was dried. To the dry powder, 0.1 g tartaric acid is added as an activating agent, along with 0.5 g bentonite clay, 0.5 g polyvinylacetate, and 0.5 g polyethylenimine as binders, before forming by a tableting, granulation or extrusion process. The concentration of the sodium chlorite in the final tablet is 10.0 wt. %.

### Example 27

1.0 gram of sodium chlorite was dissolved in 15 milliliters of water, and slowly added to 9.0 grams of dry silica powder until incipient wetness. The impregnated power was dried. 0.1 g tartaric acid was added as an activating agent, 2.0 g polyhexamethylene biguanide and 0.2 g copper sulfate were added as co-disinfectants, and 0.5 g bentonite clay, 0.5 g polyvinylacetate, and 0.5 g polyethylenimine were added as binders, before forming by a tableting, granulation or extrusion process. The concentration of the sodium chlorite in the final tablet is 10.0 wt. %.

### Example 28

1.0 gram of sodium chlorite was dissolved in 18 milliliters of water, and slowly added to 9.0 gram of dry zeolite 4A until incipient wetness. The impregnated power was dried. To the dry powder, 0.1 g tartaric acid was added as an activating agent, along with 0.5 g bentonite clay, 0.5 g polyvinylacetate, and 0.5 g polyethylenimine as binders, before forming by a tableting, granulation or extrusion process. The concentration of the sodium chlorite in the final tablet is 10.0 wt. %.

### Example 29

1.0 gram of sodium chlorite was dissolved in 23 milliliters of water, and slowly added to 9.0 grams of dry zeolite 13X until incipient wetness. The impregnated power was dried. 0.1 g tartaric acid was added as an activating agent, 2.0 g polyhexamethylene biguanide and 0.2 g copper sulfate were added as co-disinfectants, and 0.5 g bentonite clay, 0.5 g polyvinylacetate, and 0.5 g polyethylenimine were added as binders, before forming by a tableting, granulation or extrusion process. The concentration of the sodium chlorite in the final tablet is 10.0 wt. %.

### Example 30

1.0 gram of sodium chlorite was dissolved in 11 milliliters of water, and slowly added to 9.0 grams of montmorillonite until incipient wetness. The impregnated power was dried. 0.1 g tartaric acid was added as an activating agent, 2.0 g polyhexamethylene biguanide and 0.2 g copper sulfate were added as co-disinfectants, and 0.5 g bentonite clay, 0.5 g polyvinylacetate, and 0.5 g polyethylenimine were added as binders, before forming by an extrusion process. The concentration of the sodium chlorite in the final tablet is 10.0 wt. %.

### Example 31

2.0 grams of sodium chlorite was mixed with 7.0 grams silylated cellulose. Then, 0.2 gram of tartaric acid was added as an activating agent, and 0.5 grams of polyvinyl acetate, and 0.3 grams of polyethylenimine were added as binders. The mixture was then compacted into a container with an opening for diffusion of water and release of activated sodium chlorite. The concentration of the sodium chlorite in the final tablet is 20.0 wt. %.

### Example 32

2.0 grams of sodium chlorite was mixed with 5.0 grams of silylated cotton. 0.2 grams of tartaric acid was added to the mixture as an activating agent, 2.0 g polyhexamethylene biguanide and 0.2 g copper sulfate were added as co-disinfectants, and 0.5 g polyvinylacetate, and 0.5 g polyethylenimine were added as binders. The mixture was then compacted into a container with an opening for diffusion of water and release of activated sodium chlorite. The concentration of the sodium chlorite in the final tablet is 20.0 wt. %.

### Example 33

400 g tetraethyl orthosilicate was mixed vigorously with 120 g of 0.14 M nitric acid in an ice bath. Once cooled near room temperature, 20 grams of sodium chlorite was added under vigorous mixing. Afterward, 200 g of 40% Ludox AS-40 colloidal silica sol was added dropwise. The concentration of the sodium chlorite in the final tablet is 1.6 wt. %.

### Example 34

400 g tetraethyl orthosilicate was mixed vigorously with 120 g of 0.14 M nitric acid in an ice bath. Once cooled near room temperature, 5 grams of sodium chlorite was added under vigorous mixing. 20 grams of polyhexamethylene biguanide was added as a co-disinfectant. Afterward, 200 g of 40% Ludox AS-40 colloidal silica sol was added dropwise to form a hydrogel. The concentration of the sodium chlorite in the final tablet is 0.4 wt. %.

### Example 35

200 g tetraethyl orthosilicate was mixed vigorously with 120 g of 0.14 M nitric acid in an ice bath. Once cooled near room temperature, 5 grams of sodium chlorite and 200 g of water were added under vigorous mixing. 20 grams of polyhexamethylene biguanide was added as a co-disinfectant. Afterward, 200 g of 40% Ludox AS-40 colloidal silica sol was added dropwise to form a hydrogel. The concentration of the sodium chlorite in the final tablet is 0.4 wt. %.

### Example 36

400 g tetraethyl orthosilicate was mixed vigorously with 120 g of 0.14 M nitric acid in an ice bath. Once cooled near room temperature, 20 grams of sodium chlorite was added under vigorous mixing. 20 grams of polyhexamethylene biguanide and 2 grams copper sulfate were added as co-disinfectants. Afterward, 200 g of 40% Ludox AS-40 colloidal silica sol was added dropwise to form a hydrogel. The concentration of the sodium chlorite in the final tablet is 1.6 wt. %.

### Example 37

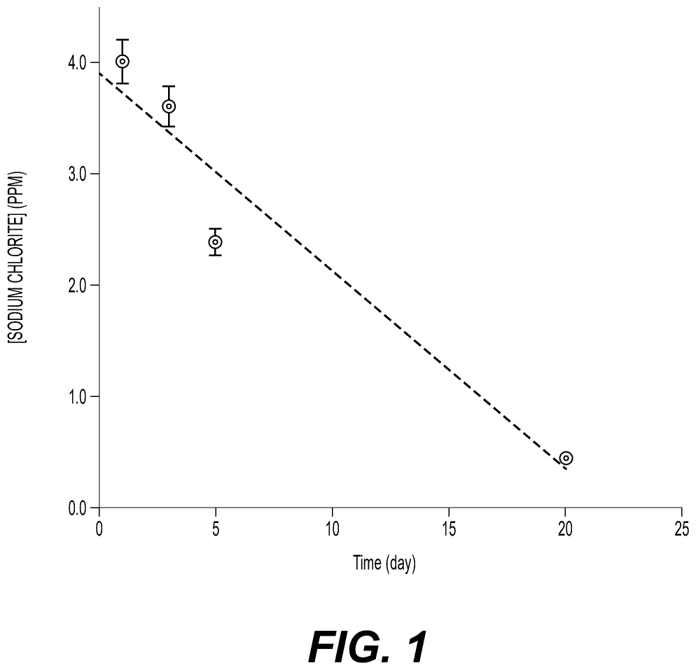

In order to examine sodium chlorite dosing, a 20 g silica hydrogel matrix containing 1.6 wt. % sodium chlorite was immersed in 2 liters of water. Water samples were taken every 24 hours over 20 days and the water was replaced. A typical sodium chlorite concentration from dosing is plotted in FIG. 1.

### Example 38

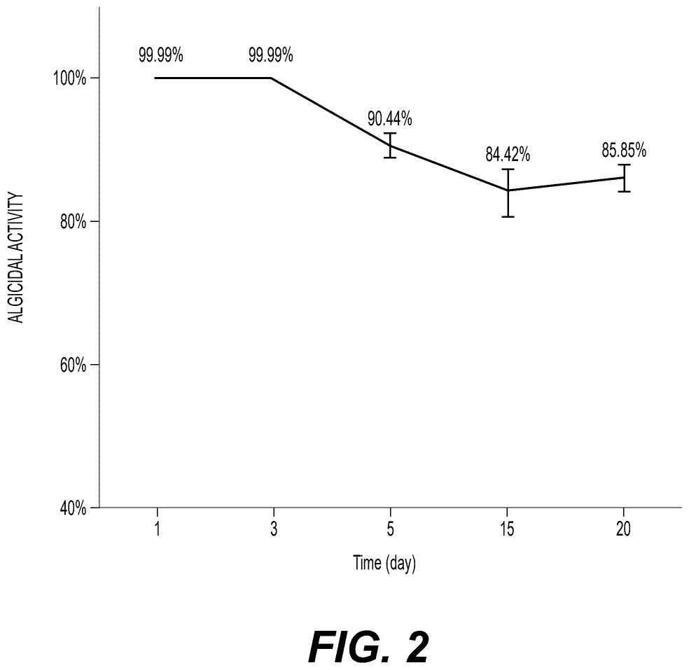

In order to studying algicidal activity, a water sample taken from the sodium chlorite dosing of Example 37 was mixed with 100 parts of water containing a culture of live Chlorella autotrophica for 10 min. The live and dead algae were quantified after staining and microscopy observations. The algicidal activity over 20 days is plotted in FIG. 2.

### Example 39

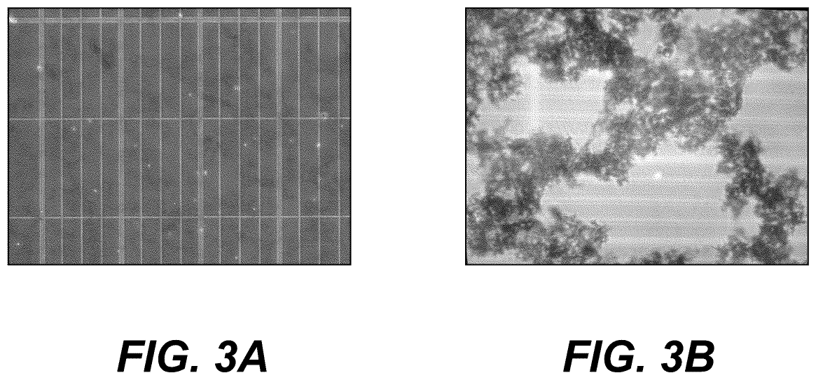

Field trials were conducted in two water reservoirs. The larger reservoir (1800 m³) served as the test site and the smaller reservoir (1500 m³) served as the control. A 1 g sample per m³ of water was used over an observation period of 10 days. The viable Chlorella spp. algae was quantified by taking periodic water samples and observing under the microscope, as shown in FIGS. 3A and 3B.

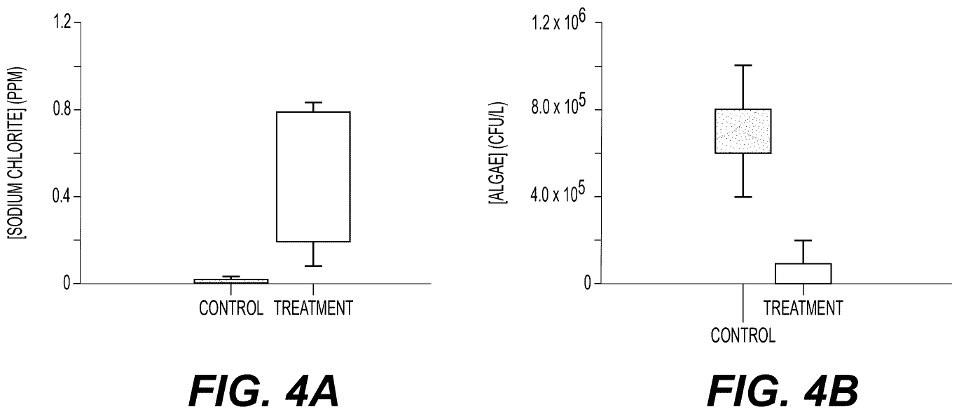

As shown in FIGS. 4A and 4B, the mean concentrations of chlorine dioxide were 0.01 ppm and 0.46 ppm with the corresponding algae concentrations of 7×10⁵ per liter and 5×10⁴ per liter for the control and test reservoirs, respectively, over the 10-day observation period. The sodium chlorite tablet maintained 92.8 percent less algae in the test reservoir compared to the control reservoir.

It is to be understood that the sodium chlorite tablet for controlling algal growth in water and the method of making the same are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A sodium chlorite tablet, comprising:
a matrix material;
sodium chlorite having a concentration between 0.5 wt. % and 20 wt. % of the sodium chlorite tablet; and
a binding agent having a concentration less than or equal to 5.0 wt. % of the sodium chlorite tablet.

2. The sodium chlorite tablet as recited in claim 1, wherein the matrix material comprises sand.

3. The sodium chlorite tablet as recited in claim 1, wherein the binding agent is selected from the group consisting of a polymer binder, a clay binder, a silica binder, bentonite clay, polyvinylacetate, polyethylenimine and combinations thereof.

4. The sodium chlorite tablet as recited in claim 1, wherein the matrix material comprises an inorganic powder.

5. The sodium chlorite tablet as recited in claim 4, wherein the inorganic powder is selected from the group consisting of silica powder, inorganic oxide powder, zeolite powder, porous inorganic oxide powder, and clay powder.

6. The sodium chlorite tablet as recited in claim 5, wherein the inorganic oxide powder is selected from the group consisting of alumina oxide powder, alumina oxide-silica oxide powder, titania powder, and combinations thereof.

7. The sodium chlorite tablet as recited in claim 5, wherein the porous inorganic oxide powder is selected from the group consisting of porous silica oxide powder, porous alumina oxide powder, porous alumina oxide-silica oxide powder and combinations thereof.

8. The sodium chlorite tablet as recited in claim 1, wherein the matrix material comprises silylated cellulose.

9. The sodium chlorite tablet as recited in claim 8, wherein the silylated cellulose is selected from the group consisting of silylated methyl cellulose, silylated carboxymethyl cellulose, silylated cotton and combinations thereof.

10. The sodium chlorite tablet as recited in claim 1, wherein the matrix material comprises a silica hydrogel.

11. A method of making a sodium chlorite tablet, comprising:
mixing a matrix material with sodium chlorite to form a first mixture;
mixing a binding agent with the first mixture to form a second mixture; and
tableting the second mixture to form a sodium chlorite tablet,
wherein the sodium chlorite has a concentration between 0.5 wt. % and 20 wt. % of the sodium chlorite tablet, and
wherein the binding agent has a concentration less than or equal to 5.0 wt. % of the sodium chlorite tablet.

12. The method of making a sodium chlorite tablet as recited in claim 11, further comprising adding an activating agent to the first mixture.

13. The method of making a sodium chlorite tablet as recited in claim 12, wherein the activating agent is selected from the group consisting of tartaric acid impregnated activated carbon, tartaric acid powder, citric acid impregnated activated carbon, and maleic acid impregnated activated carbon.

14. The method of making a sodium chlorite tablet as recited in claim 11, wherein the matrix material comprises sand.

15. The method of making a sodium chlorite tablet as recited in claim 11, wherein the binding agent is selected from the group consisting of a polymer binder, a clay binder, a silica binder, nitric acid, bentonite clay, polyvinylacetate, polyethylenimine and combinations thereof.

16. The method of making a sodium chlorite tablet as recited in claim 11, wherein the matrix material comprises an inorganic powder.

17. The method of making a sodium chlorite tablet as recited in claim 16, wherein the inorganic powder is selected from the group consisting of silica powder, inorganic oxide powder, zeolite powder, porous inorganic oxide powder, clay powder.

18. The method of making a sodium chlorite tablet as recited in claim 17, wherein the inorganic oxide powder is selected from the group consisting of alumina oxide powder, alumina oxide-silica oxide powder, titania powder, and combinations thereof.

19. The method of making a sodium chlorite tablet as recited in claim 17, wherein the porous inorganic oxide powder is selected from the group consisting of porous silica oxide powder, porous alumina oxide powder, porous alumina oxide-silica oxide powder and combinations thereof.

20. The method of making a sodium chlorite tablet as recited in claim 11, wherein the matrix material comprises silylated cellulose.

21. The method of making a sodium chlorite tablet as recited in claim 20, wherein the silylated cellulose is selected from the group consisting of silylated methyl cellulose, silylated carboxymethyl cellulose, silylated cotton and combinations thereof.

22. The method of making a sodium chlorite tablet as recited in claim 12, further comprising added a co-disinfectant to the first mixture.

23. The method of making a sodium chlorite tablet as recited in claim 22, wherein the co-disinfectant is selected from the group consisting of polyhexamethylene biguanide, copper sulfate, and a combination thereof.

24. A method of making a sodium chlorite tablet, comprising:
diluting colloidal silica sol in water;
adding sodium chlorite to the diluted colloidal silica sol to form a mixture; and
placing the mixture in a tablet mold and allowing conversion of the colloidal silica sol into a gel.

25. The method of making a sodium chlorite tablet as recited in claim 24, further comprising adding a co-disinfectant to the mixture.

26. The method of making a sodium chlorite tablet as recited in claim 25, wherein the co-disinfectant is selected from the group consisting of polyhexamethylene biguanide, copper sulfate, and a combination thereof.
